(19) United States
(12) Patent Application Publication
(10) Pub. No.: US 2024/0400289 A1
(43) Pub. Date: Dec. 5, 2024

(54) CRYOGENIC SHIPPER

(71) Applicant: Cryoport, Inc., Brentwood, TN (US)

(72) Inventors: James Wilbourn, Costa Mesa, CA (US); Ben Lee, Corona, CA (US); Mike Dybicz, Nashville, TN (US); Bobby Onel, Laguna Beach, CA (US); David Nelson, Irvine, CA (US); Garrett Grommes, Brentwood, TN (US)

(73) Assignee: Cryoport, Inc., Brentwood, TN (US)

(21) Appl. No.: 18/678,733

(22) Filed: May 30, 2024

Related U.S. Application Data
(60) Provisional application No. 63/469,717, filed on May 30, 2023.
(60) Provisional application No. 63/570,139, filed on Mar. 26, 2024.

(51) Int. Cl. B65D 81/38; F17C 13/08

(52) U.S. Cl. CPC B65D 81/3823; F17C 13/086; F17C 2205/0111; F17C 2205/0169

(57) ABSTRACT

Hardened reusable shipping containers (e.g., shippers) are disclosed herein. A shipper may have a base enclosure that is configured to receive a payload and maintain a temperature of an environment surrounding the payload. The shipper may have various features such as bosses, compartments, and surface features to facilitate protection of a dewar inside the base enclosure, and retention of a payload during shipment. The shipper may have various features to facilitate ready stacking of shippers and suitability for use in air cargo operations.

### CROSS REFERENCE TO RELATED APPLICATIONS

This application is based upon and claims the benefit of and priority to (1) U.S. Provisional Patent Application No. 63/469,717 entitled “MEDIUM VOLUME CRYOGENIC SHIPPER,” filed on May 30, 2023, and (2) U.S. Provisional Patent Application No. 63/570,139 entitled “HARDENED REUSABLE SHIPPER,” filed on Mar. 26, 2024, the entire content of each of which is incorporated by reference herein.

### BACKGROUND

### 1. Field

The various aspects and embodiments described herein relate to shipping containers, particularly hardened reusable shippers.

### 2. Description of the Related Art

In the health, medical, pharmaceutical, and/or life science industries, safe storage and fast transportation of payloads in a temperature-controlled and watertight environment is important. Hardened reusable shipping containers that maintain, regulate, or control the payload area temperature are desirable in transporting temperature sensitive payloads in such industries. The payload area temperature may be maintained by using phase change materials (e.g., dry ice) and/or cryogenic liquids (e.g., liquid nitrogen). Due to the temperature sensitive nature of the shipments, issues with shipping that lead to delivery delay may result in the payload being expired, spoiled, reduced quality, or damaged. Moreover, rough handling may result in the payload being damaged. As such, there is a need for a hardened reusable shipping container with improvements to enhance ruggedness, provide for easy display of shipping addresses, instructions, and payload-specific information to a handler, and discourage improper handling of the hardened reusable shipping container to mitigate or eliminate delivery delays and prevent damage to the payload.

### SUMMARY

Hardened reusable shippers are disclosed herein. A shipper may be configured to retain a dewar for shipment. The shipper may include a base having an inner compartment wall defining an inner compartment to receive a dewar. The shipper may include a lid selectably closable over the inner compartment to secure the dewar therein. The lid may include a front registration boss to be received by an aspect of another shipper to permit stacking of shippers. The front registration boss may include a front primary ramp portion of increasing height away from the base in at least one dimension along a first direction, a front bend portion curving along a path of changing direction, and a front secondary ramp portion of increasing height away from the base in at least the at least one dimension along a second direction. The front primary ramp portion extends from a front primary ramp portion terminus to the front bend portion. The front secondary ramp portion extends from a front secondary ramp portion terminus to the front bend portion. A height away from the base of the front bend portion is a greatest height of any portion of the front registration boss away from the base. The at least one registration boss causes the shipper to wobble in response to the shipper being rested on the lid rather than on the base.

One or more further aspects may be included. For instance, the lid may include a rear registration boss spaced apart from the front registration boss and to be received by the aspect of the another shipper to permit stacking of shippers. The rear registration boss may include a rear primary ramp portion of increasing height away from the base in the at least one dimension along the first direction, a rear bend portion curving along a path of changing direction, and a rear secondary ramp portion of increasing height away from the base in at least the at least one dimension along the second direction. The rear primary ramp portion extends from a rear primary ramp portion terminus to the rear bend portion. The rear secondary ramp portion extends from a rear secondary ramp portion terminus to the rear bend portion. The height away from the base of the rear bend portion is the greatest height any portion of the rear registration boss away from the base. The rear registration boss causes the shipper to wobble in response to the shipper being rested on the lid rather than on the base.

In various embodiments, the rear primary ramp portion and the front primary ramp portion are parallel. In various embodiments, the rear secondary ramp portion and the front secondary ramp portion are parallel. The rear bend portion and the front bend portion may be a same size. The rear secondary ramp portion may be smaller than the rear primary ramp portion. The rear primary ramp portion and the front primary ramp portion may be of a first same size and the rear secondary ramp portion, and the front secondary ramp portion may be of a second same size, the second same size being smaller than the first same size.

In various embodiments, the base further includes a document compartment wall defining a document compartment within the inner compartment, the document compartment defining a subsection of the inner compartment. A foam stabilization block system may be provided. The foam stabilization block system may include a plurality of foam blocks inserted into the inner compartment, each foam block of the plurality of foam blocks having an outer profile edge corresponding in shape to at least a portion of the inner compartment wall and having an inner profile edge corresponding in shape to at least a portion of the dewar.

A shipper configured to retain a dewar for shipment is provided. The shipper may include a base having an inner compartment wall defining an inner compartment to receive the dewar. The shipper may include a lid selectably closable over the inner compartment to secure the dewar therein. The base may include a strengthening face opposite the lid. The strengthening face may have a base floor parallel to the lid when the lid is closed and having an annular channel defining an annular bead of the base floor. The annular channel may include an inward bend face providing a first curved bend of the strengthening face inwardly away from the base floor and into the inner compartment.

One or more further aspects may be included. The annular channel may have a basin face providing an inwardmost floor of the annular channel, a tangent of the basin face parallel to at least a portion of the base floor. The annular channel may include an outward bend face providing a second curved bend of the strengthening face outwardly from the basin face and away from the inner compartment and toward the base floor. The strengthening face may further include a central recess.

The central recess may provide a joining plane joining all outermost points of the second curved bend. The joining plane may be a circle. The joining plane may be parallel to the base floor and nearer to the lid than the base floor.

In various embodiments, (i) the base floor, (ii) the inward bend face, (iii) the basin face, (iv) the outward bend face, and (v) the central recess are all inset toward the lid by a inset wall surrounding the base floor and extending normal to each of the lid, the base floor, and the joining plane. The surrounding inset wall may define a closed perimeter of the base floor. The base floor may define a closed perimeter of the annular channel. The annular channel may define a closed perimeter of the central recess.

In various embodiments, the first curved bend has a profile corresponding to a profile of a portion of the dewar. The dewar is nestable against at least a portion of the strengthening face inside the inner compartment. In various embodiments, the first curved bend has a profile corresponding to a profile of a portion of the dewar and a distance between the dewar and the strengthening face measured in a direction normal to the strengthening face is a constant distance. A foam block may be received into the constant distance. The strengthening face may support the foam block. The foam block may support the dewar.

In various embodiments, a shipper is configured to retain a dewar for secure shipment. The shipper may include a base. The base may include an inner compartment wall defining an inner compartment to receive the dewar. The shipper may include a lid selectably closable over the inner compartment to secure the dewar therein. The base may have a strengthening face opposite the lid. The strengthening face may have a base floor parallel to the lid when the lid is closed. The strengthening face may have an inset wall providing a central region of the base surrounded by the base floor and inset toward the lid relative to the base floor. The inset wall spaces the dewar received in the inner compartment away from the base floor so that the base elevates the dewar away from the base floor. The elevating of the dewar away from the base floor may at least partially mechanically isolate the dewar from direct vibratory conduction from a resting surface under the base.

### BRIEF DESCRIPTION OF THE DRAWINGS

Other apparatus, methods, features, and advantages of the present disclosure will be apparent to one skilled in the art upon examination of the following figures and detailed description. Component parts shown in the drawings are not necessarily to scale and may be exaggerated to better illustrate the important features of the present disclosure.

FIG. 1A shows an external perspective view of a shipper configured to retain a dewar for shipment with a lid of the shipper closed, in accordance with various embodiments;

FIGS. 1B-C show two opposite side views a shipper configured to retain a dewar for shipment with a lid of the shipper closed, in accordance with various embodiments;

FIG. 1D shows a top view of a shipper configured to retain a dewar for shipment with a lid of the shipper closed and the view oriented downward toward the closed lid, in accordance with various embodiments;

FIG. 1E shows a front view of a shipper configured to retain a dewar for shipment with a lid of the shipper closed, in accordance with various embodiments;

FIG. 1F shows a rear view of a shipper configured to retain a dewar for shipment with a lid of the shipper closed, in accordance with various embodiments;

FIG. 2 shows an external perspective view of a shipper configured to retain a dewar for shipment, with a lid of the shipper opened to show the dewar, in accordance with various embodiments;

FIG. 3 shows an exploded view of a foam stabilization block system installable into an inside of a shipper configured to retain a dewar for shipment, with a lid of the shipper opened to show the dewar and the exploded view of the foam stabilization block system, in accordance with various embodiments;

FIG. 4 shows a view of an inner compartment of a base of a shipper configured to retain a dewar for shipping, and specifically, a document compartment having a document compartment wall within the inner compartment, in accordance with various embodiments;

FIG. 5 shows a detailed view of a document compartment, including a projected profile top view and a projected profile bottom view of the same illustrated in exploded view format, in accordance with various embodiments;

FIG. 6A shows a bottom view of a shipper configured to retain a dewar for shipment, the bottom of the shipper including registration depressions and a strengthening face, in accordance with various embodiments;

FIG. 6B shows a partial cutaway side view of a shipper having a dewar therein, the view detailing aspects of the strengthening face, in accordance with various embodiments;

FIG. 7 shows a full cutaway side view of a shipper configured to retain a dewar for shipment with a lid of the shipper closed, as well as the dewar therein, in accordance with various embodiments;

FIG. 8 illustrates a side cross sectional view of a cubical shipper, in accordance with various embodiments;

FIGS. 9A and 9B illustrate perspective views of a cylindrical shipper, in accordance with various embodiments;

FIG. 9C illustrates a side cross sectional view of a cylindrical shipper comprising a stacking system, in accordance with various embodiments;

FIG. 9D illustrates a top down perspective view of a cylindrical shipper, in accordance with various embodiments;

FIGS. 10A and 10B illustrate perspective views of a cylindrical shipper comprising a document storage lid, in accordance with various embodiments;

FIG. 10C illustrates a top down perspective view of a cylindrical shipper comprising a document storage lid, in accordance with various embodiments;

FIG. 10D illustrates a side view of a cylindrical shipper comprising a document storage lid with a stacking system, in accordance with various embodiments; and

FIG. 11 illustrates a side view of a cylindrical shipper comprising a dome shaped stacking system, in accordance with various embodiments.

### DETAILED DESCRIPTION

Disclosed herein are hardened reusable shipping containers (or “shippers”). The shippers may maintain, regulate, or control a temperature or a temperature range within a payload area. Systems including cryogenic liquids and/or phase change materials may be used in conjunction with the shippers to set or maintain the temperature inside the payload area at a desired temperature or temperature range. The desired temperature or temperature range may be a temperature or temperature range that preserves a payload within the payload area before, during, and/or after shipment. The shippers may be made from a hardened material (e.g., polycarbonate, polyethylene, etc.) that protects the payload from environmental factors including shock and vibration. Further, the shippers may be decontaminated and cleaned, thereby allowing reuse of the shippers.

Some of the shippers may maintain, regulate, or control the temperature or the temperature range within the payload area for a limited time. As such, swift delivery of the payload is important to prevent the temperature within the payload area from changing to an undesirable temperature or temperature range that may damage the payload. Errors such as mishandling or misdelivering the shippers may cause or contribute to delays in shipment, thus jeopardizing the payload. Shippers having features to facilitate easy review of shipping and handling information ameliorate errors. Shippers having features to enhance ruggedness and shippers having features to discourage improper handling also ameliorate damage.

Finally, airline procedures for airborne cargo limit the availability of shipping by air of conventional dewars or other vessels having non-rectilinear shapes. As such, development of a shipper that also exhibits a rectilinear shape and securely retains a dewar (which may have a shape disallowed for air cargo) may enhance the availability of air shipment and facilitate swift delivery to prevent undesirable temperature excursions and damage to the payload.

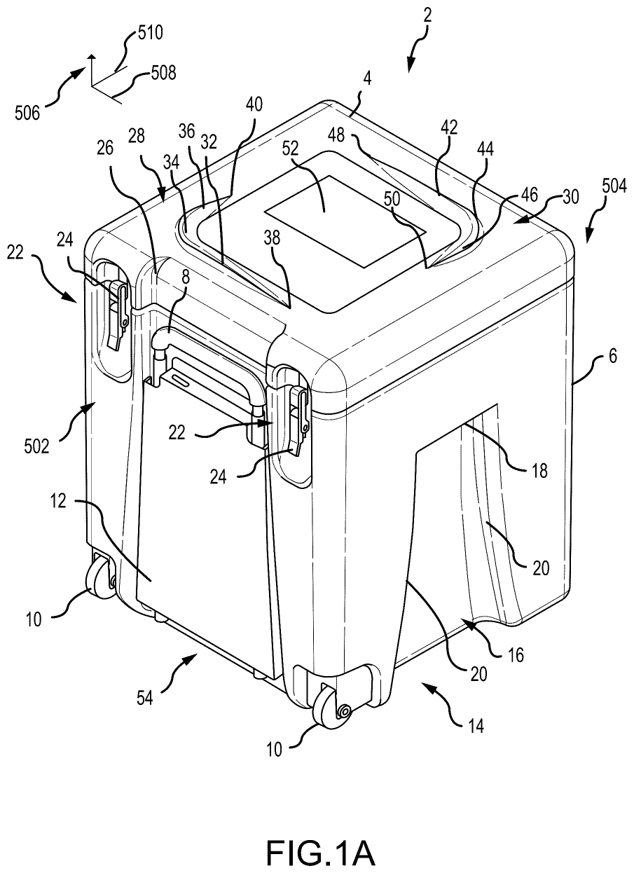

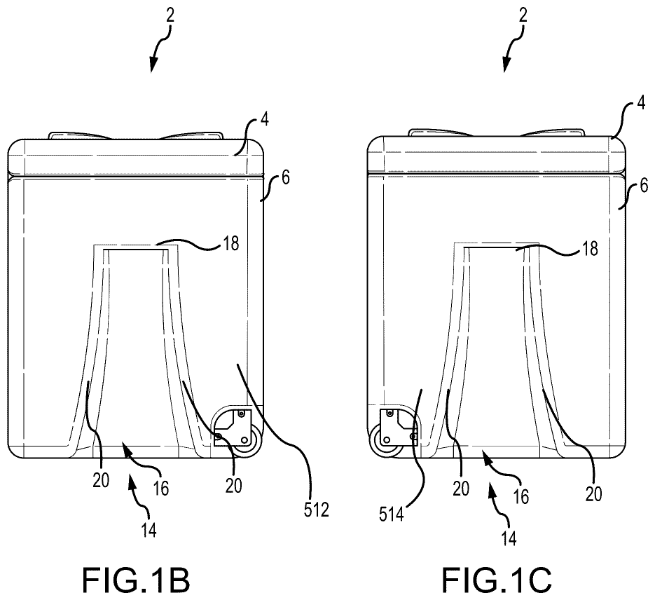

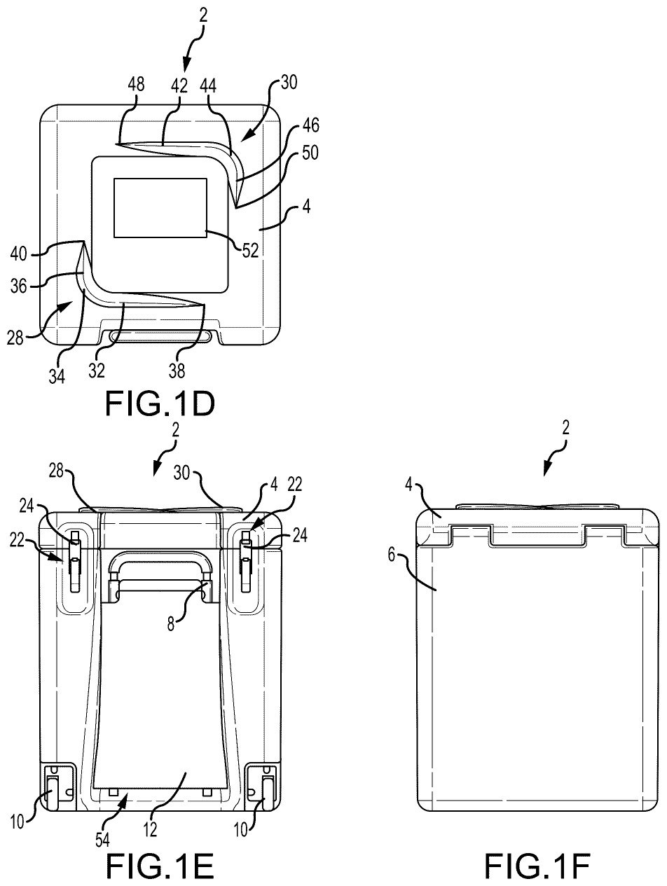

Referring now to FIGS. 1A-F, various views of a shipper 2 are depicted. The shipper 2 may be a container having a shape suitable for air freight shipment and configured to receive a dewar therein. The shipper 2 may be rectangular, or square, or rectilinear. The shipper 2 may be trapezoidal or any suitable shape. The shipper 2 may have surface features, channels, and cut outs to facilitate different functions and aspects. For instance, aspects that may protrude beyond an edge plane of the shipper 2, disrupting the shape (e.g., disrupting a rectilinear profile) may be placed in dents, impressions, channels, cutouts, and the like, to ameliorate disruption to the shape (e.g., the rectilinear profile). The shipper 2 may be stackable. The shipper 2 may resist rolling or toppling. The shipper 2 may be made of plastic, metal, or another suitable material to provide desired rigidity, flexibility, or other material properties.

In various embodiments, the shipper 2 has a lid 4 and a base 6. The base 6 may comprise a larger body of the shipper 2 and may be structured to secure a dewar therein. The lid 4 may comprise a smaller body of the shipper 2 and may be removably couplable and/or hingably coupled to the base 6 to selectably close the base 6 to selectably enclose the dewar secured therein.

The shipper 2 may have a handle 8. The handle 8 may be attached to a side of the base 6. In various embodiments, the handle 8 may be extendible, for example by telescoping outward for use by a person manipulating the shipper 2, then telescoping inward for storage.

The shipper 2 may have one or more wheel 10. The shipper 2 may have two wheels 10 or four wheels 10 or any number of wheels 10. The wheel 10 may be a rolling apparatus to facilitate easy movement of the shipper 2. In various embodiments, two wheels 10 are attached to the shipper 2 and are biased toward a same face of the shipper 2 to facilitate rolling when the shipper 2 is tilted toward the wheels 10, and to resist rolling when the shipper 2 is tilted away from the wheels 10 to rest on the base 6 of the shipper 2.

The shipper 2 may have a detachable plate 12. The detachable plate 12 may comprise a cleanable surface suitable for adherence by stickers. Labels, instructions, or other information may be printed on stickers and adhered to the detachable plate 12. The detachable plate 12 may be removable for cleaning. In various embodiments, the detachable plate 12 comprises bent sheet metal shaped to protect at least a portion of the handle 8 from inadvertent contact when in the inward position for storage.

The shipper 2 may have one or more latch 24. The latch 24 may be an apparatus configured to effectuate selectable closure of a combination of the lid 4 and the base 6. The shipper 2 may have two latches 24 spaced apart on a front of the base 6 and selectably engageable to corresponding aspects near an edge of the lid 4. The latches 24 may include clips, buckles, ties, hooks, or any other latch configuration.

The shipper 2 may have a shipping label 52. The shipping label may be an electronic label module. In various embodiments, an electronic display screen, such as an e-ink display provides shipping information, address labels, or the like. In further instances, the shipping label 52 may be a conventional adhesive shipping label.

Having generally introduced each feature of the shipper 2, attention is now directed to the lid 4 for a discussion of particular aspects of the lid 4. In various embodiments, a lid 4 may include a handle channel 26. A handle channel 26 may comprise a cut out, depression, or other relief structure to provide for unobstructed passage of the handle 8 between outwardly telescoped (extended) and inwardly telescoped (retracted) positions without requiring manipulation or opening or closing of the lid 4.

The lid 4 may include a front registration boss 28. The front registration boss 28 may be a boss (e.g., a raised surface feature) extending upwardly (in direction 506) away from the lid 4 on an upper side of the lid 4 when the lid 4 is closed. The front registration boss 28 may be biased toward one side of the shipper 2 (e.g., a front side 502 of the shipper 2). The front registration boss 28 may facilitate alignment of another shipper 2 when the other shipper 2 is stacked on top of the lid 4 for storage or transportation. The boss may interact with a corresponding feature on a bottom of a base 6 of the other shipper 2 so that the shipper 2 more securely rests in place atop the front registration boss 28.

Similarly, the lid 4 may have a rear registration boss 30. A rear registration boss 30 may be a boss (e.g., a raised surface feature) extending upwardly (in direction 506) away from the lid 4 on an upper side of the lid 4 when the lid 4 is closed. The rear registration boss 30 may be biased toward one side of the shipper 2 (e.g., a rear side 504 of the shipper 2). The rear registration boss 30 may be biased toward an opposite side of the shipper 2 than the front registration boss 28 (e.g., rear side 504 is opposite of front side 502). The rear registration boss 30 may facilitate alignment of another shipper 2 when the other shipper 2 is stacked on top of the lid 4 for storage or transportation. The boss may interact with a corresponding feature on a bottom of a base 6 of the other shipper 2 so that the shipper 2 more securely rests in place atop the rear registration boss 30.

The front registration boss 28 and the rear registration boss 30 may each have various features. For instance, the front registration boss 28 may have a front primary ramp portion 32 that ramps away from the lid 4 upwardly (in direction 506) a greater and greater distance from an origin point at the front primary ramp portion terminus 38 to a highest point at the front bend portion 34. The front bend portion 34 may be a curved portion of the front registration boss 28 where the boss curves from a first direction 508 toward a second direction. For instance, the front registration boss 28 may run parallel to an edge of the lid 4 (or in any other direction) along the front primary ramp portion 32 (e.g., in first direction 508), then may run in a changing direction (e.g., curving) along the front bend portion 34, and may then run in a second direction 510, such as being parallel to a different edge of the lid 4 (or in any other direction) along a front secondary ramp portion 36. The front secondary ramp portion 35 may ramp away from the lid 4 upwardly (in direction 506) a greater and greater distance from an origin point at a front secondary ramp portion terminus 40 to the highest point at the front bend portion 34.

The rear registration boss 30 may have a rear primary ramp portion 42 that ramps away from the lid 4 upwardly (in direction 506) a greater and greater distance from an origin point at the rear primary ramp portion terminus 48 to a highest point at the rear bend portion 44. The rear bend portion 44 may be a curved portion of the rear registration boss 30 where the boss curves from a direction toward another direction. For instance, the rear registration boss 30 may run parallel to an edge of the lid 4 (or in any other direction) along the rear primary ramp portion 42 (e.g., in first direction 508), then may run in a changing direction (e.g., curving) along the rear bend portion 44, and may then run in another direction, such as being parallel to a different edge of the lid 4 (or in any other direction) along a rear secondary ramp portion 46 (e.g., in second direction 510). The rear secondary ramp portion 46 may ramp away from the lid 4 upwardly (in direction 506) a greater and greater distance from an origin point at a rear secondary ramp portion terminus 50 to the highest point at the rear bend portion 44.

The front registration boss 28 and the rear registration boss 30 may cooperate to orient and secure a further shipper 2 stacked on top of the lid 4 for storage or transportation. For instance, the following discussion will detail example configurations of the front registration boss 28 and the rear registration boss 30. Then, the discussion will detail example cooperating features of the front registration boss 28 and the rear registration boss 30.

For instance, in various embodiments, the lid 4 comprises a front registration boss 28 to be received by an aspect of another shipper 2 to permit stacking of shippers, the front registration boss 28 comprising a front primary ramp portion 32 of increasing height away from the base 6 in at least one dimension along a first direction 508. The front registration boss 28 may include a front bend portion 34 curving along a path of changing direction and a front secondary ramp portion 36 of increasing height away from the base 6 in at least the at least one dimension along a second direction 510. The front primary ramp portion 32 extends from a front primary ramp portion terminus 38 to the front bend portion 34. The front secondary ramp portion 35 extends from a front secondary ramp portion terminus 40 to the front bend portion 34. A height away from the base 6 of the front bend portion 34 is a greatest height of any portion of the front registration boss 28 away from the base 6, and the at least one registration boss (e.g., front registration boss 28) causes the shipper 2 to wobble in response to the shipper 2 being rested on the lid 4 rather than on the base 6. Thus, the front registration boss 28 may also discourage improper positioning of the shipper 2, such as upside down positioning.

The lid 4 may include a rear registration boss 30 spaced apart from the front registration boss 28 and to be received by the aspect of another shipper 2 to permit stacking of shippers. The rear registration boss 30 may include a rear primary ramp portion 42 of increasing height away from the base 6 in the at least one dimension along the first direction 508. The rear registration boss 30 may include a rear bend portion 44 curving along a path of changing direction. The rear registration boss 30 may include a rear secondary ramp portion 46 of increasing height away from the base 6 in at least the at least one dimension along the second direction 510. The rear primary ramp portion 42 extends from a rear primary ramp portion terminus 48 to the rear bend portion 44. The rear secondary ramp portion 46 extends from a rear secondary ramp portion terminus 50 to the rear bend portion 44. The height away from the base 6 of the rear bend portion 44 is the greatest height any portion of the rear registration boss 30 away from the base 6. The rear registration boss 30 causes the shipper 2 to wobble in response to the shipper 2 being rested on the lid 4 rather than on the base 6.

The front registration boss 28 and the rear registration boss 30 cooperate in various aspects. For instance, in various embodiments, the rear primary ramp portion 42 and the front secondary ramp portion 36 are parallel. In various embodiments, the rear secondary ramp portion 46 and the front primary ramp portion 32 are parallel. The rear bend portion 44 and the front bend portion 34 may be a same size. The rear secondary ramp portion 46 may be smaller than the rear primary ramp portion 42. The rear primary ramp portion 42 and the front primary ramp portion 32 may be of a first same size and the rear secondary ramp portion 46 and the front secondary ramp portion 36 may be of a second same size, the second same size being smaller than the first same size.

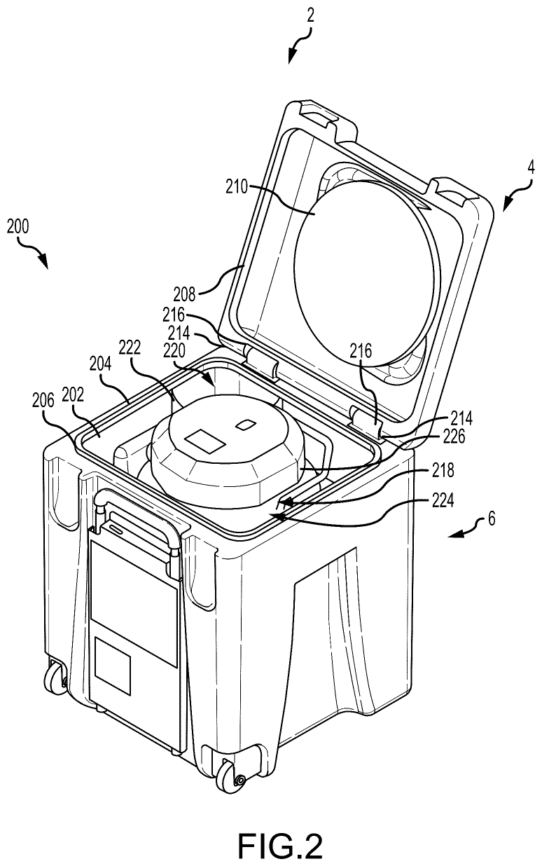

Referring to both FIGS. 1A-1F and to FIG. 2, the lid 4 includes a lid sealing face 208. The lid sealing face 208 may be a face protruding from an underside of the lid 4 to be received at least partially into a feature of the base 6 to enhance thermal sealing and to provide securement against inadvertent shearing away of the lid 4 from the base 6 when the lid 4 is closed.

The lid 4 may include a dewar retention boss 210. While the dewar retention boss 210 is shown as a disk in the figures, other shapes are also contemplated. The dewar retention boss 210 may comprise a compressible boss extending downwardly from an underside of the lid 4 to rest against a dewar lid 226 of a dewar 218 being stored in the base 6 and press against the dewar lid 226 of the dewar 218, compressing and securing the dewar 218 from inadvertent movements or jostling. In various instances, the dewar retention boss 210 may be foam, or another compressible material.

Finally, the lid 4 may include a lid-side hinge portion 214. The lid-side hinge portion 214 may comprise a tab, or a hinge pin, or a hinge pin receiver, or another aspect of a hinge that corresponds to a base-side hinge portion 216 on the base 6. Lid-side hinge portion 214 may interoperate with the base-side hinge portion 216 to provide a hinge feature to allow hingable opening of the lid 4 relative to the base 6. Similarly, the base 6 may include a base-side hinge portion 216. The base-side hinge portion 216 may comprise a tab, or a hinge pin, or a hinge pin receiver, or another aspect of a hinge that corresponds to a lid-side hinge portion 214 on the lid 4. Base-side hinge portion 216 may interoperate with the lid-side hinge portion 214 to provide a hinge feature to allow hingable opening of the lid 4 relative to the base 6.

Having introduced each aspect of the lid 4, attention is now directed to FIGS. 1A-F for a discussion of the base 6. In various embodiments, the base 6 comprises one or more relief channels 14 defined into one or more side of the base 6. A side of the base may be a face of the base 6 connecting the front side 502 of the base 6 and the rear side 504 of the base 6. For example, a first side 512 is shown in FIG. 1B and a second side 514 is shown in FIG. 1C. An indentation may run along a portion of a side 512, 514 of the base 6 and terminate at a ledge 18. The ledge 18 may be an abrupt end of the indentation, returning the side 512, 514 of the base 6 to a generally rectangular geometry, thus providing a grasping surface for a hand to lift the shipper 2 by grabbing the ledge 18. In various embodiments, the relief channel 14 includes an entry passageway 16, comprising an indentation running along at least a portion of a side 512, 514 of the base 6, such as running from a bottom of the base 6 and at least partially up a side 512, 514 of the base 6 toward the lid 4. The relief channel 14 may include a ledge 18, which comprises an ending of the entry passageway 16 to provide a grasping surface for lifting the shipper 2. In various embodiments, the relief channel 14 is bound on each side of the relief channel 14 by a guidance ramp 20. The guidance ramp 20 may be angled, or curved, or may be normal to a bottom of the shipper 2. Thus, a pair of guidance ramps 20, and a ledge 18 may define the inner boundaries of the entry passageway 16. Two entry passageways 16 may be included, with each on opposite sides 512, 514 of the base 6 to give space for two hands to grasp and maneuver the shipper 2. In further instances, the relief channel 14 may be shaped to interface with a machine device for lifting and moving the shipper 2.

As mentioned previously, the shipper 2 may have one or more latch 24. Each latch 24 may be disposed in a corresponding latch channel 22 of the base 6. A latch channel 22 may comprise a depression, local indentation, and or the like. The latch channel 22 may provide relief space to dispose a latch 24 in connection to the base 6 and of use in securing the lid 4 but may provide protection to the latch 24 from inadvertent contact, impact, and/or the like as the shipper 2 is moved about.

The shipper 2 may further include a surface feature channel 54. A surface feature channel 54 may comprise a channel to provide relief space for a handle 8 and for a detachable plate 12. In this manner, the surface feature channel 54 provides relief space to dispose the handle 8 and the detachable plate 12 parallel to a profile of the base 6 or inset relative to the profile of the base 6 to provide protection from inadvertent contact, impact, and/or the like as the shipper 2 is moved about.

Directing attention now to FIG. 2, the base 6 may further include an inner compartment 200. The inner compartment 200 may be a cavity defined inside the base 6 and enclosable by a combination of the base 6 and the lid 4. An inner compartment wall 202 of the base 6 may define the inner compartment 200.

The inner compartment 200 may have various features. For instance, the inner compartment 200 may have an inner compartment sealing ridge 204. The inner compartment sealing ridge 204 may be a local raised feature extending around a perimeter of an opening into the inner compartment 200 and structured to interface with one or more corresponding feature of the lid 4. The inner compartment sealing ridge 204 may extend at least partially into the lid 4 on an underside of the lid 4 to ameliorate any unwanted shearing of the lid 4 relative to the base 6 during rough handling of the shipper 2. The inner compartment sealing ridge 204 may further provide enhanced thermal sealing, restricting gas or heat transfer through the area where the lid 4 and the base 6 open and close. In various embodiments, the inner compartment 200 also includes an inner compartment sealing face 206. The inner compartment sealing face 206 comprises a face of the inner compartment sealing ridge 204 that contacts against the lid 4. For example, an outer perimeter face of the inner compartment sealing ridge 204 that is an outward-most face of the inner compartment sealing ridge 204 relative to the inner compartment wall 202 may be the inner compartment sealing face 206.

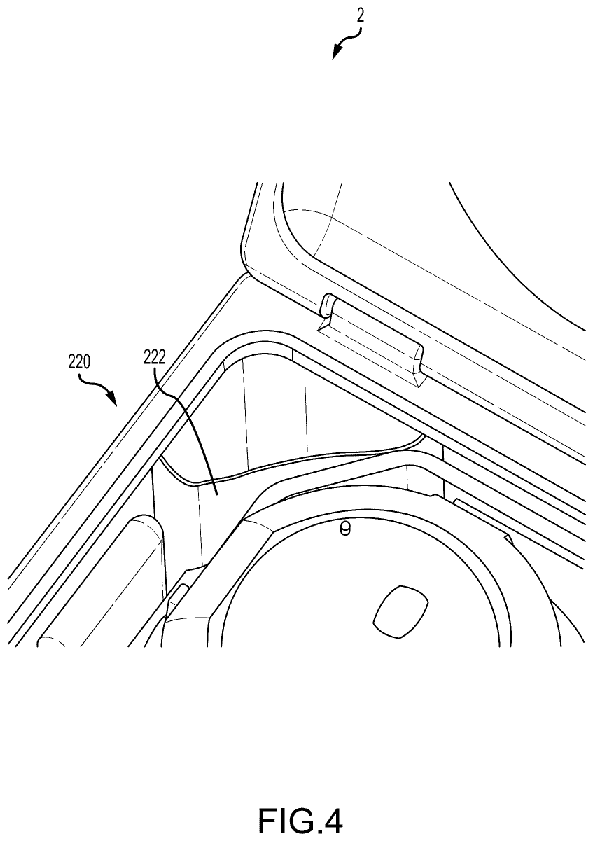

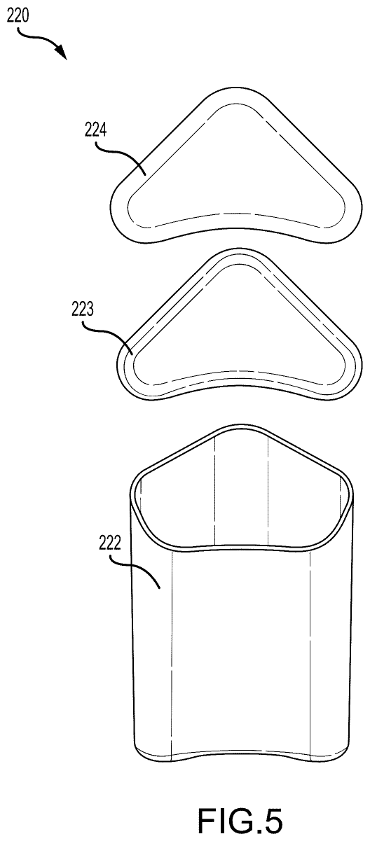

With reference to FIGS. 2, 4, and 5, the inner compartment 200 may include document compartment 220. The document compartment 220 may be a separate container defined by a document compartment wall 222. The document compartment 220 may be inserted into the inner compartment 200 and may provide a separated area to secure documents inside of the inner compartment 200. Thus, a base 6 may comprise a document compartment wall 222 defining a document compartment 220 within the inner compartment 200, the document compartment 220 defining a subsection of the inner compartment 200. FIG. 5 also illustrates a top profile view 224 of the document compartment, such as a lid of the document compartment and a bottom profile view 223 of the document compartment such as a floor of the document compartment.

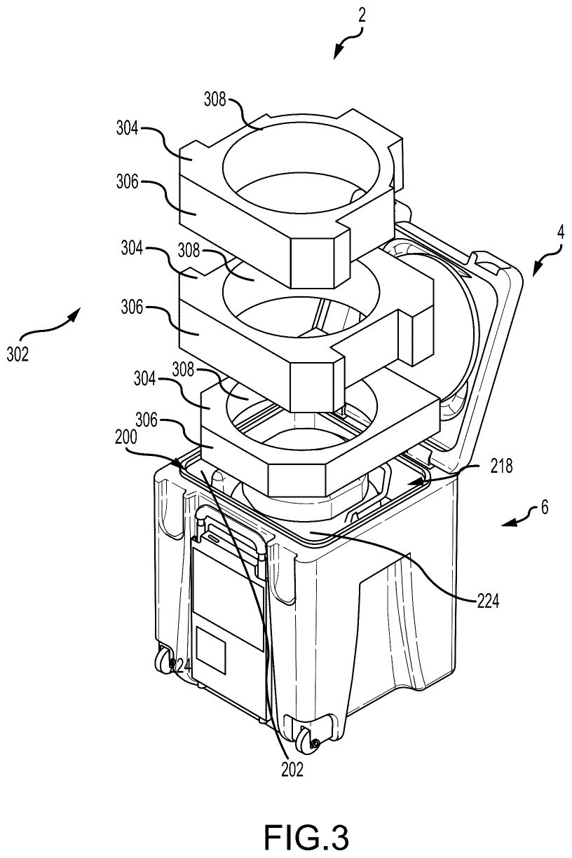

Turning now to FIGS. 2 and 3, in various embodiments, the inner compartment 200 further includes a foam stabilization block system 302. The foam stabilization block system 302 includes one or more foam blocks 304 to stabilize a dewar 218 in the inner compartment 200. The foam blocks 304 may occupy space between a vessel 224 of the dewar 218 and an inner compartment wall 202 of the inner compartment 200. In various embodiments, different foam blocks 304 of different shapes may be implemented. For instance, because dimensions of the inner compartment wall 202 and of the dewar 218 may be different at different locations, the dimensions of the foam blocks 304 may also need to vary to appropriately occupy space in the inner compartment 200 to limit jostling and movement of the dewar 218. For instance, three foam blocks 304 may be inserted, though any other number may be contemplated. Each foam block 304 may have an outer profile edge 306 comprising a surface of the foam block 304 that contacts the inner compartment wall 202 and may have an inner profile edge 308 comprising a surface of the foam block 304 that contacts the dewar 218, such as the vessel 224 of the dewar 218. Thus, the shipper 2 may include a foam stabilization block system 302 comprising a plurality of foam blocks 304 inserted into the inner compartment 200, each foam block 304 of the plurality of foam blocks 304 having an outer profile edge 306 corresponding in shape to at least a portion of the inner compartment wall 202 and having an inner profile edge 308 corresponding in shape to at least a portion of the dewar 218.

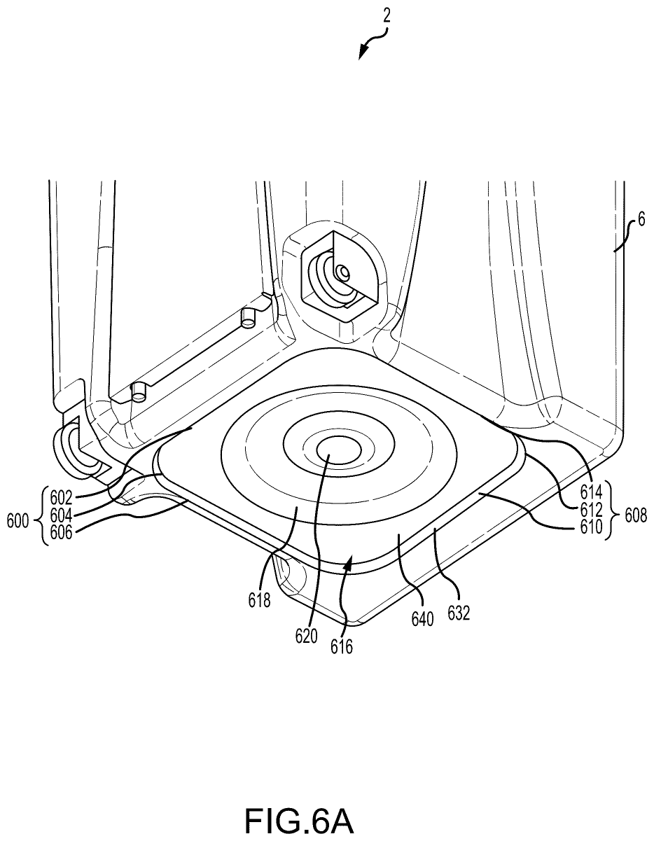

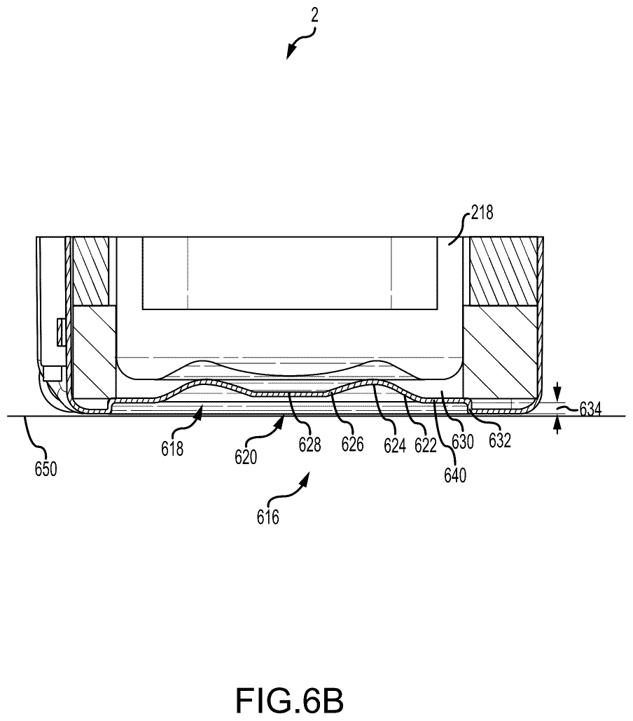

Turning now to FIGS. 6A-B, but with periodic reference to FIGS. 1A-1F, further aspects of the base 6 include various features of a bottom of the base 6. In earlier paragraphs, the front registration boss 28 (FIG. 1A-1F) and rear registration boss 30 (FIG. 1A-1F) of the lid 4 (FIG. 1A-1F) were detailed. These registration bosses may be received into corresponding depressions on a base 6 when a base 6 of one shipper 2 is stacked onto the lid 4 of another shipper 2. For example, the base 6 may include a front registration depression 600 to receive a front registration boss 28. Similarly, the base 6 may include a rear registration depression 608 to receive a rear registration boss 30.

The front registration depression 600 may include a front primary ramp receiver 602. The front primary ramp receiver 602 may comprise an abutting surface shaped to abut against a front primary ramp portion 32 of a front registration boss 28. Similarly, the front registration depression 600 may include a front bent portion receiver 604. The front bent portion receiver 604 may include an abutting surface shaped to abut against a front bend portion 34. Likewise, the front registration depression 600 may include a front secondary ramp receiver 606. The front secondary ramp receiver 606 may include an abutting surface shaped to abut against a front secondary ramp portion 36 of the front registration boss 28.

The rear registration depression 608 may include a rear primary ramp receiver 610. The rear primary ramp receiver 610 may comprise an abutting surface shaped to abut against a rear primary ramp portion 42 of a rear registration boss 30. Similarly, the rear registration depression 608 may include a rear bent portion receiver 612. The rear bent portion receiver 612 may include an abutting surface shaped to abut against a rear bend portion 44. Likewise, the rear registration depression 608 may include a rear secondary ramp receiver 614. The rear secondary ramp receiver 614 may include an abutting surface shaped to abut against a rear secondary ramp portion 46 of the rear registration boss 30.

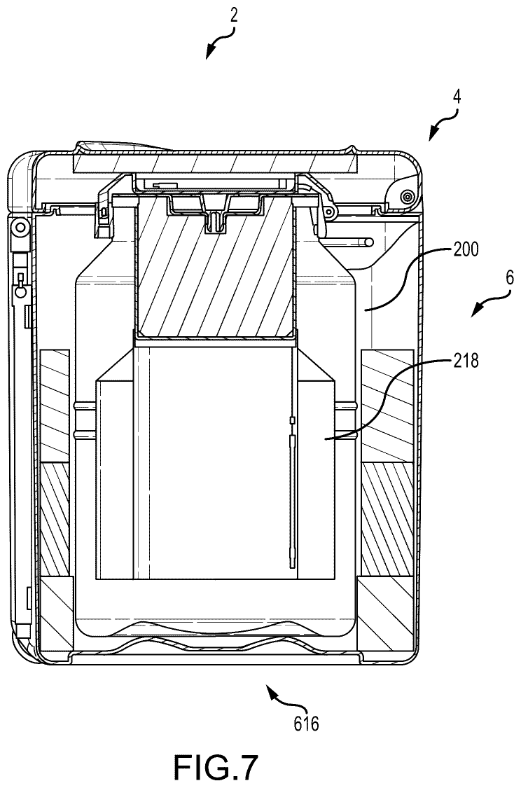

The base 6 may include a strengthening face 616. The strengthening face 616 may comprise a group of features that strengthens a bottom of the base 6, such as by including beads, ribs, bends, and other strengthening geometry. Moreover, the strengthening face 616 may include beads, ribs, bends, and other strengthening geometry that also facilitates spacing and or securement of a dewar 218 that is inside an adjacent inner compartment 200 (FIG. 7) of the base 6.

The strengthening face 616 may comprise a base floor 640. The base floor 640 may comprise a planar area. The base floor 640 may be inset an inset distance 634 toward the lid 4 (FIG. 1A-1F) by an inset wall 632 that extends normal to the base floor 640. By insetting the base floor 640, a gap may be formed between a surface that the base 6 rests on and a region of the base 6 corresponding to the base floor 640. This gap may provide for the front registration depression 600 and the rear registration depression 608. This gap may provide for further cushioning and/or isolation of a dewar 218 inside the base 6, as will be discussed herein below. The strengthening face 616 may include an annular channel 618. The annular channel 618 may be a channel further inset relative to the base floor 640 and extending from the base floor 640. The annular channel 618 may be a curved channel and may correspond to a shape of a similar curve on a bottom of a dewar 218 that rests inside the base 6. The annular channel 618 may join to a central recess 620 defined at a center of an annulus of the annular channel 618. The central recess 620 may comprise a planar feature parallel to the base floor 640. For example, a joining plane 628 may fill the center of the annulus of the annular channel 618.

The annular channel 618 may have a variety of shapes. For example, the annular channel 618 may be a triangular channel (e.g., an annulus having a triangle cross-section). The annular channel 618 may be a trapezoidal channel (e.g., an annulus having a trapezoidal cross-section). The annular channel 618 may be an arcuate channel (e.g., an annulus having an arcuate cross-section). In some instances, the arcuate channel may have a cross-section that is a curve such as a portion of a circle. For example, the annular channel 618 may have an inward bend face 622 that bends inwardly toward a lid 4 (FIG. 1A-1F) of the shipper 2 (FIG. 1A-1F), a basin face 624 that is an inward most portion of the annular channel 618, and an outward bend face 626 that bends outwardly in a direction at least partially opposite that of the inward bend face 622 and that connects the basin face 624 to the joining plane 628 of the central recess 620.

Thus, with continuing reference to FIGS. 6A-B, reference to FIG. 7, as well as periodic reference to FIGS. 1A-1F and 2, a shipper 2 configured to retain a dewar 218 for shipment may include a base 6 comprising an inner compartment wall 202 defining an inner compartment 200 to receive the dewar 218 and a lid 4 selectably closable over the inner compartment 200 to secure the dewar 218 therein. The base 6 comprises a strengthening face 616 opposite the lid 4, the strengthening face 616 having a base floor 640 parallel to the lid 4 when the lid 4 is closed and comprising an annular channel 618 defining an annular bead of the base floor 640. The annular channel 618 may include an inward bend face 622 comprising a first curved bend of the strengthening face 616 inwardly away from the base floor 640 and into the inner compartment 200.

The annular channel 618 may also have a basin face 624 comprising an inwardmost floor of the annular channel 618. A tangent of the basin face 624 may be parallel to at least a portion of the base floor 640. The annular channel 618 may also have an outward bend face 626 comprising a second curved bend of the strengthening face 616 outwardly from the basin face 624 and away from the inner compartment 200 and toward the base floor 640. The strengthening face 616 further comprises a central recess 620, the central recess 620 comprising a joining plane 628 joining all outermost points of the second curved bend. The joining plane 628 may be a circle. The joining plane 628 may be parallel to the base floor 640 and nearer to the lid 4 than is the base floor 640. In various embodiments, (i) the base floor 640, (ii) the inward bend face 622, (iii) the basin face 624, (iv) the outward bend face 626, and (v) the central recess 620 are all inset toward the lid 4 by a inset wall 632 surrounding the base floor 640 and extending normal to each of the lid 4, the base floor 640, and the joining plane 628, the surrounding inset wall 632 defining a closed perimeter of the base floor 640, the base floor 640 defining a closed perimeter of the annular channel 618, and the annular channel 618 defining a closed perimeter of the central recess 620.

In various instances, the inward bend face 622 comprising a first curved bend has a profile corresponding to a profile of a portion of the dewar 218 and the dewar 218 is nestable against at least a portion of the strengthening face 616 inside the inner compartment 200. In some embodiments, the inward bend face 622 comprising the first curved bend has a profile corresponding to a profile of a portion of the dewar 218. A distance between the dewar 218 and the at least the portion of the strengthening face 616 measured in a direction normal to the strengthening face 616 is a constant distance. Furthermore, a foam block 630 may be received into the constant distance, and the strengthening face 616 may support the foam block 630 and the foam block 630 may support the dewar 218.

In various example embodiments, the shipper 2 is configured to retain a dewar 218 for secure shipment and includes a base 6 comprising an inner compartment wall 202 defining an inner compartment 200 to receive the dewar 218. The shipper 2 includes a lid 4 selectably closable over the inner compartment 200 to secure the dewar 218 therein. The base 6 has a strengthening face 616 opposite the lid 4, the strengthening face 616 having a base floor 640 parallel to the lid 4 when the lid 4 is closed and comprising an inset wall 632 comprising a central region of the base 6 surrounded by the base floor 640 and inset toward the lid 4 relative to the base floor 640. The inset wall 632 spaces the dewar 218 received in the inner compartment 200 away from the base floor 640 so that the base 6 elevates the dewar 218 away from the base floor 640 to at least partially mechanically isolate the dewar 218 from direct vibratory conduction from a resting surface 650 under the base 6.

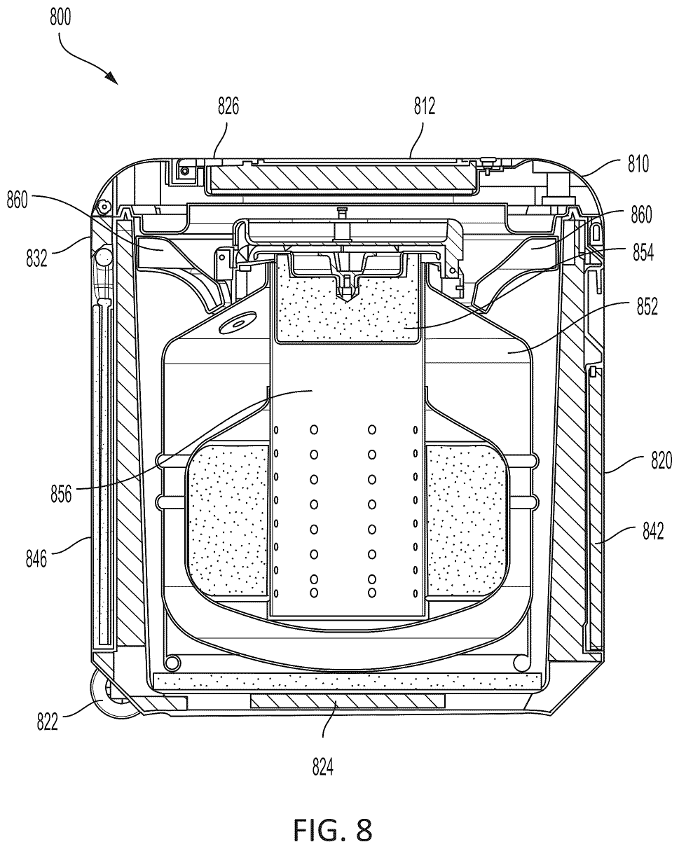

With reference to FIG. 8, a cubical shipper 800 is shown, in accordance with various embodiments. The cubical shipper may comprise a lid 810 and a body 820. The cubical shipper 800 may comprise a front panel 842, side panels, a back panel 846, a bottom panel 824, and a top panel 826. In various embodiments, the bottom panel 824 and top panel 826 may be square shaped.

In various embodiments, the lid 810 may be attached to the body 820. For example, the lid 810 may be attached to the body 820 by a hinge 832. The lid 810 may be configured to rotate upward on a pivot to allow access to the internal components of the cubical shipper 800.

In various embodiments, the lid 810 may comprise electronic labeling 812. For example, electronic labeling 812 may be connected to the top of the lid 810. The electronic labeling 812 may include monitoring and tracking electronics. In various embodiments the electronic labeling 812 can comprise the electronic shipping label as described in U.S. Patent Pub. No. 2019/0303862, which is incorporated herein by reference in its entirety. The electronic labeling 812 may provide a real-time display for any type of shipping label configuration regardless of carrier (i.e., bar-coding, formatting, and carrier specific information required etc.). Further, when modifications are or changes for the shipping label are desired, a web portal will send the new information to the electronic labeling 812 to change the display via an electronic device carried with the shipper, such as a smart data logger or a separate electronic device. Origin, destination, payload, and carrier can all be changed via some type of communication to the label (such as Wi-Fi, cellular or some other type of contactless communication) from the smart data logger or separate electronic device. The electronic labeling 812 may comprise a user interface including a user interface element, a button, a dial, a microphone, a keyboard, or a touch screen. The electronic labeling 812 may receive electronic image file containing a shipping label and store a plurality of electronic image files containing shipping labels.

In various embodiments, the cubical shipper 800 may include mechanical labeling. In various embodiments, the mechanical labeling may be attached to the front panel 842 of the cubical shipper 800 or the back panel 846, or any suitable location. The mechanical labeling may be removable. For example, the mechanical labeling may comprise information regarding the mechanical aspects of the cubical shipper, for example hold time, usage or various other container specifications.

In various embodiments, the cubical shipper 800 may comprise wheels 822. The wheels 822 may be positioned on the bottom of the body 820. The wheels 822 may allow the cubical shipper 800 to be more easily transported.

In various embodiments, the lid 810 and body 820 may be made of plastic or other materials. The body 820 and lid 810 may be configured to both insulate and protect the internal contents, described in more detail below. The lid 810 and body 820 may provide external protection to the internal contents and ease of transportation.

In various embodiments, a vapor plug 854 may seal or partially seal the dewar 852. That is, the vapor plug 854 allows the liquid or gas to escape the dewar 852 to at least partially equalize the pressure within the dewar 852 relative to an external pressure, but may also, obstruct and/or reduce the amount of liquid or gas that escapes to limit evaporation and limit warm air from entering into the dewar 852. This maintains the cryogenic temperatures within the dewar 852 to allow for continued cryogenic storage of the material stored within the dewar 852.

The cubical shipper 800 may comprise support structures 860. In various embodiments, the support structures 860 may stabilize the dewar 852. The support structures 860 may provide support to the dewar 852 so that the dewar 852 does not shift during movement of the cubical shipper 800. In various embodiments, the support structures 860 may be removably attached to the cubical shipper 800.

In various embodiments, the lid 810 may be lifted to access the dewar 852. The dewar 852 may be removed from the body 820 of the cubical shipper 800. This allows the dewar 852 to be easily recharged. In various embodiments, the dewar 852 can then be inserted into the body 820. The dewar may comprise a payload area 856. The payload area 856 may be configured to receive a payload, such as biological materials that require cold storage.

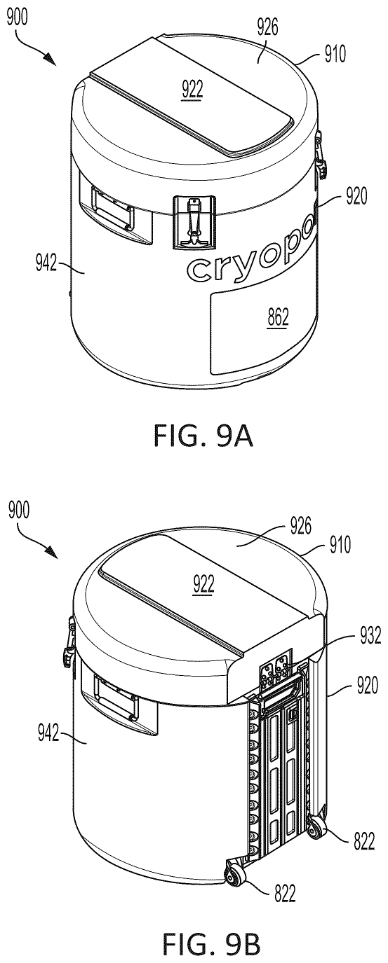

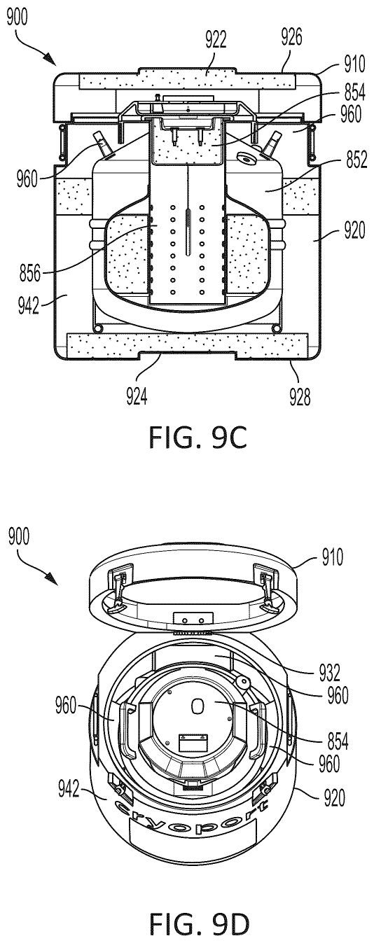

With reference to FIGS. 9A through 9D, a cylindrical shipper 900 is shown, in accordance with various embodiments. The cylindrical shipper 900 may be similar in design and function to the cubical shipper 800 (FIG. 8), however the cylindrical shipper 900 comprises a cylindrical shape. The cylindrical shipper 900 may comprise a lid 910 and a body 920. The cylindrical shipper 900 may comprise an outer panel 942, a top panel 926, and a bottom panel 928. The outer panel 942 may be a cylinder panel on the outer portion of the cylindrical shipper 900. In various embodiments, the top panel 926 and bottom panel 928 may be circular shaped.

In various embodiments, the lid 910 may be attached to the body 920. For example, the lid 910 may be attached to the body 920 by a hinge 932. The lid 910 may be configured to rotate upward on a pivot to allow access to the internal components of the cylindrical shipper 900.

In various embodiments, the cylindrical shipper 900 may comprise mechanical labeling 862. For example, outer panel 942 may comprise mechanical labeling 862.

In various embodiments, the cylindrical shipper 900 may comprise wheels 822. The wheels 822 may be positioned on the bottom of the body 920. The wheels 822 may allow the cylindrical shipper 900 to be more easily transported.

In various embodiments, the cylindrical shipper 900 may be made of plastic or other insulative materials. For example, the lid 910 and body 920 may be made of plastic or other materials. The body 920 and lid 910 may be configured to both insulate and protect the internal contents. The lid 910 and body 920 may provide external protection to the internal contents and ease of transportation.

With reference to FIG. 9C, a side cross sectional view of a cylindrical shipper 900 is shown, in accordance with various embodiments. The cylindrical shipper 900 may comprise a dewar 852 and a vapor plug 854. The dewar 852 and vapor plug 854 may be similar in design and function as described in reference to FIG. 8.

Referring to FIGS. 9A-9D, the cylindrical shipper 900 may further comprise support structures 960. In various embodiments, the support structures 960 may stabilize the dewar 852. The support structures 960 may provide support to the dewar 852 so that the dewar 852 does not shift during movement of the cylindrical shipper 900. In various embodiments, the support structures 960 may be removably attached to the cylindrical shipper 900.

In various embodiments, the lid 910 may be lifted to access the dewar 852. The dewar 852 may be removed from the body 920 of the cylindrical shipper 900. This allows the dewar 852 to be easily recharged. In various embodiments, the dewar 852 can then be inserted into the body 920. The dewar may comprise a payload area 856. The payload area 856 may be configured to receive a payload, such as biological materials that require cold storage.

In various embodiments, the cylindrical shipper 900 may comprise a stacking ridge 922 and a stacking indent 924. For example, the stacking ridge 922 may be positioned on the top of the lid 910. The stacking indent 924 may be positioned on the bottom of the body 920. The stacking indent 924 may be configured to be inserted into a stacking ridge 922. The stacking ridge 922 and stacking indent 924 may be configured to fit inside each other to prevent movement during shipping or storage.

In various embodiments, one or more support structures 960 may secure the dewar 852. The support structures 960 may be used to hold the dewar 852 in place during transportation. The lid 910 may be opened to access the dewar 852.

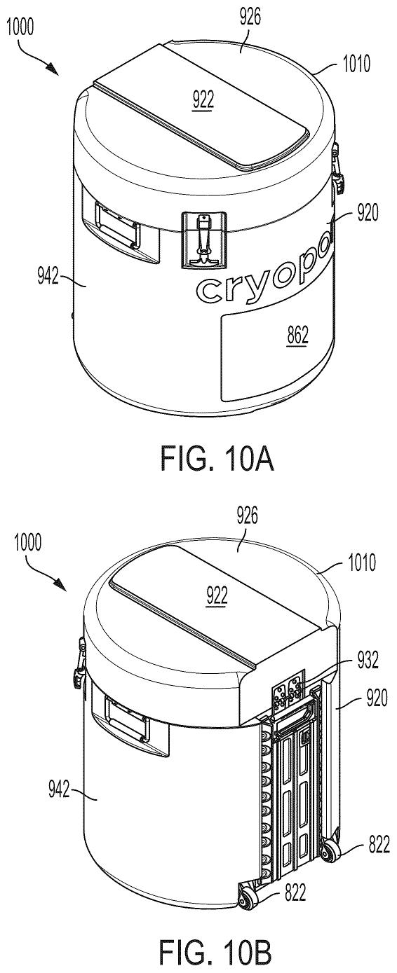

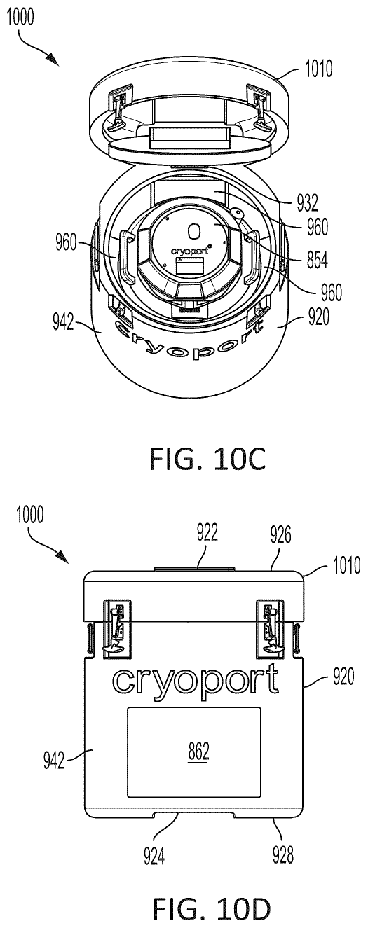

With reference to FIGS. 10A-10D a cylindrical shipper 1000 comprising a document storage lid 1010 is shown, in accordance with various embodiments. The cylindrical shipper 1000 may be similar in design and function as cylindrical shipper 900 (FIGS. 9A-D) and may have similar aspects with reference numbers in the 900 series being same or similar features as those described with reference to FIGS. 9A-D. The cylindrical shipper 1000 may have similar aspects with reference numbers in the 800 series being same or similar features as those described with reference to FIG. 8 and others. The cylindrical shipper 1000 further comprises a document storage lid 1010. In various embodiments, the document storage lid 1010 may comprise a container or protected area for documents. For example, the document storage lid 1010 may contain documents or other materials separated from the dewar, thus protected from the cryogenic temperature and moisture of the dewar. In various embodiments, the document storage lid 1010 may protect various documents, such as documents related to the payload or medical records.

With reference to FIG. 10D, a cylindrical shipper 1000 may comprise a stacking ridge 922 and a stacking indent 924, as described with reference to FIG. 10D.

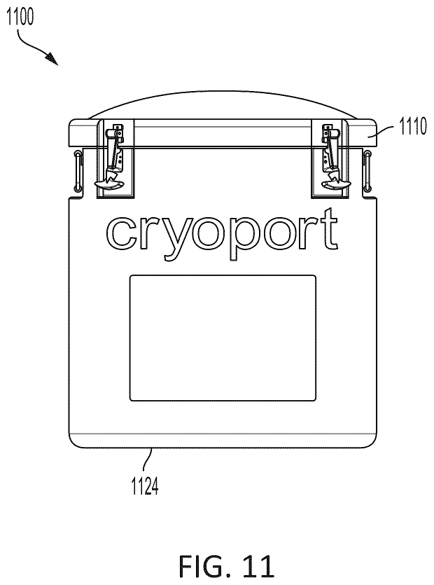

With reference to FIG. 11, a side view of a cylindrical shipper 1100 comprising dome shaped stacking system, in accordance with various embodiments. The cylindrical shipper 1100 may be similar to cylindrical shipper 900 (FIGS. 9A-9D). The cylindrical shipper may comprise a dome shaped lid 1110, and a dome shaped indented base 1124. The dome shaped lid 1110 may be configured to stack with a dome shaped indented base 1124.

Thus, one may appreciate that cubical shipper may be provided. The cubical shipper may have a body configured to hold a dewar, the body having a square base. The cubical shipper may have a lid attached to the body by a hinge, the lid comprising an electronic labeling system. The cubical shipper may have one or more support structures for holding the dewar inside the body.

A cylindrical shipper may be provided. The cylindrical shipper may have a body configured to hold a dewar, the body having a circular base, the circular base having a stacking indent. The cylindrical shipper may have a lid attached to the body by a hinge, the lid comprising an electronic labeling system and a stacking ridge, wherein the stacking ridge is configured to stack with the stacking indent of a second cylindrical shipper. The cylindrical shipper may have one or more support structures for holding the dewar inside the body.

A method of securing a dewar in a cylindrical shipper may be provided. The method may include inserting a dewar into a body of the cylindrical shipper, the cylindrical shipper having a circular base. The method may include closing a lid to the body, wherein the lid attached to the body by a hinge. The method may also include supporting the dewar in the body by one or more support structures.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

1. A shipper configured to retain a dewar for shipment, the shipper comprising:
a base comprising an inner compartment wall defining an inner compartment to receive the dewar; and
a lid selectably closable over the inner compartment to secure the dewar therein,
wherein the lid comprises a front registration boss to be received by an aspect of another shipper to permit stacking of shippers, the front registration boss comprising:
a front primary ramp portion of increasing height away from the base in at least one dimension along a first direction;
a front bend portion curving along a path of changing direction; and
a front secondary ramp portion of increasing height away from the base in at least the at least one dimension along a second direction,
wherein the front primary ramp portion extends from a front primary ramp portion terminus to the front bend portion,
wherein the front secondary ramp portion extends from a front secondary ramp portion terminus to the front bend portion,
wherein a height away from the base of the front bend portion is a greatest height of any portion of the front registration boss away from the base, and
wherein the front registration boss causes the shipper to wobble in response to the shipper being rested on the lid rather than on the base.

2. The shipper according to claim 1, wherein the lid comprises a rear registration boss spaced apart from the front registration boss and to be received by the aspect of the another shipper to permit stacking of shippers, the rear registration boss comprising:
a rear primary ramp portion of increasing height away from the base in the at least one dimension along the first direction;
a rear bend portion curving along a path of changing direction; and
a rear secondary ramp portion of increasing height away from the base in at least the at least one dimension along the second direction,
wherein the rear primary ramp portion extends from a rear primary ramp portion terminus to the rear bend portion,
wherein the rear secondary ramp portion extends from a rear secondary ramp portion terminus to the rear bend portion,
wherein the height away from the base of the rear bend portion is the greatest height of any portion of the rear registration boss away from the base, and
wherein the rear registration boss causes the shipper to wobble in response to the shipper being rested on the lid rather than on the base.

3. The shipper according to claim 2, wherein the rear primary ramp portion and the front primary ramp portion are parallel.

4. The shipper according to claim 3, wherein the rear secondary ramp portion and the front secondary ramp portion are parallel.

5. The shipper according to claim 2, wherein the rear bend portion and the front bend portion are a same size.

6. The shipper according to claim 2, wherein the rear secondary ramp portion is smaller than the rear primary ramp portion.

7. The shipper according to claim 2, wherein the rear primary ramp portion and the front primary ramp portion are of a first same size and wherein the rear secondary ramp portion and the front secondary ramp portion are of a second same size, the second same size being smaller than the first same size.

8. The shipper according to claim 1, wherein the base further comprises a document compartment wall defining a document compartment within the inner compartment, the document compartment defining a subsection of the inner compartment.

9. The shipper according to claim 1, further comprising a foam stabilization block system comprising a plurality of foam blocks inserted into the inner compartment, each foam block of the plurality of foam blocks having an outer profile edge corresponding in shape to at least a portion of the inner compartment wall and having an inner profile edge corresponding in shape to at least a portion of the dewar.

10. A shipper configured to retain a dewar for shipment, the shipper comprising:
a base comprising an inner compartment wall defining an inner compartment to receive the dewar; and
a lid selectably closable over the inner compartment to secure the dewar therein,
wherein the base comprises a strengthening face opposite the lid, the strengthening face having a base floor parallel to the lid when the lid is closed and comprising an annular channel defining an annular bead of the base floor, the annular channel comprising:
an inward bend face comprising a first curved bend of the strengthening face inwardly away from the base floor and into the inner compartment.

11. The shipper according to claim 10, wherein the annular channel further comprises a basin face comprising an inwardmost floor of the annular channel, a tangent of the basin face parallel to at least a portion of the base floor.

12. The shipper according to claim 11, wherein the annular channel further comprises an outward bend face comprising a second curved bend of the strengthening face outwardly from the basin face and away from the inner compartment and toward the base floor.

13. The shipper according to claim 12, wherein the strengthening face further comprises a central recess, the central recess comprising a joining plane joining all outermost points of the second curved bend.

14. The shipper according to claim 13, wherein the joining plane is a circle.

15. The shipper according to claim 14, wherein the joining plane is parallel to the base floor and nearer to the lid than the base floor.

16. The shipper according to claim 15, wherein (i) the base floor, (ii) the inward bend face, (iii) the basin face, (iv) the outward bend face, and (v) the central recess are all inset toward the lid by a inset wall surrounding the base floor and extending normal to each of the lid, the base floor, and the joining plane, the surrounding inset wall defining a closed perimeter of the base floor, the base floor defining a closed perimeter of the annular channel, and the annular channel defining a closed perimeter of the central recess.

17. The shipper according to claim 10,
wherein the first curved bend has a profile corresponding to a profile of a portion of the dewar, and
wherein the dewar is nestable against at least a portion of the strengthening face inside the inner compartment.

18. The shipper according to claim 10,
wherein the first curved bend has a profile corresponding to a profile of a portion of the dewar, and
wherein a distance between the dewar and the strengthening face measured in a direction normal to the strengthening face is a constant distance.

19. The shipper according to claim 18,
wherein a foam block is received into the constant distance, and
wherein the strengthening face supports the foam block and wherein the foam block supports the dewar.

20. A shipper configured to retain a dewar for secure shipment, the shipper comprising:
a base comprising an inner compartment wall defining an inner compartment to receive the dewar; and
a lid selectably closable over the inner compartment to secure the dewar therein,
wherein the base comprises a strengthening face opposite the lid, the strengthening face having a base floor parallel to the lid when the lid is closed and comprising an inset wall comprising a central region of the base surrounded by the base floor and inset toward the lid relative to the base floor, and
wherein the inset wall spaces the dewar received in the inner compartment away from the base floor so that the base elevates the dewar away from the base floor.
